(19) United States
(12) Patent Application Publication
(10) Pub. No.: US 2007/0039555 A1
(43) Pub. Date: Feb. 22, 2007

(54) Animal accommodation pod

(76) Inventor: Michael John Tycer, Teignmouth (GB)

Correspondence Address: NIXON PEABODY, LLP, 401 9TH STREET, NW, SUITE 900, WASHINGTON, DC, 20004-2128, US

(21) Appl. No.: 11/588,386

(22) Filed: Oct. 27, 2006

(30) Foreign Application Priority Data
Oct. 28, 2002 (GB) 0521996.9

(51) Int. Cl. A01K 29/00

(52) U.S. Cl. 119/165

(57) ABSTRACT

There is provided a pod (1) for an animal. The pod (1) comprises a housing (2) including a floor (4) which is raised, in use, above a surface such as ground level. The floor (4) includes one or more apertures (7) for providing underfloor entry into and exit from the interior of the pod. There is also provided an external animal toilet pod (701).

The present invention relates generally to an accommodation pod for an animal and particularly to an accommodation pod having a floor which is raised, in use, above a surface.

It is known that animals, such as cats and dogs, enjoy having their own dedicated areas for performing various activities such as eating, sleeping and toileting. In many circumstances it is advantageous for such areas to include a floor which is raised above the ground. Access to the interior of such raised, discrete animal housings is an important consideration.

According to a first aspect of the present invention there is provided an animal accommodation pod comprising a housing including a floor which is raised, in use, above a surface, in which the floor includes one or more apertures for providing underfloor entry into and exit from the interior of the pod.

The present invention therefore provides an accommodation unit which is dedicated to the animal. The term ‘accommodation’ is intended to mean that the pod is capable of receiving an animal for various activities such as feeding, sleeping and toileting. In other words, the pod is not intended to be merely a conduit through which an animal might walk to get from one place to another, but rather a space where the animal might visit and remain to perform an activity, even though the activity might be brief.

The present invention may also relate to a pod for allowing an animal access into and out of a structure such as a building.

It is known that animals such as cats and dogs like to be able to move freely between their owner's dwelling and the external environment. To enable such animals to have this freedom, flaps, for example cat or dog flaps, are often installed into a door or wall of the owner's dwelling. These flaps allow the animal the freedom to come and go as they please.

The pod may be attachable to an interior or exterior surface of a structure.

As used herein the term “structure” shall be taken to include any dwelling, building, extension, conservatory, porch, pen, cage or vehicle. The structure may be enclosed. For example, the structure may typically be a structure comprising one or a plurality of sides which separate an interior of the structure from an external environment. The housing may be attachable to an exterior surface on a side of the structure, for example an outside wall of a dwelling. The structure may be a dwelling such as a house or apartment.

The pod may comprise a connecting aperture which, when the pod is attached to a structure surface, links the interior of the pod to the exterior or interior of a structure.

External pods have several advantages. Firstly because during use of the housing there is an area between the external underfloor aperture and the connecting aperture, the risk of someone being able to reach into the structure is much reduced. In addition because the underfloor aperture is located at least partially underneath the housing it is more difficult for someone to reach it, whilst also reducing the changes of weather such as wind or rain from entering an enclosed structure to which the housing is attached.

In some embodiments the entire aperture may be formed in the floor. In other embodiments at least 20%, 40% or 80% of the aperture may be positioned in the floor of the housing. In a most preferred embodiment 100% of the underfloor aperture may be positioned on the underside of the housing in the floor. In this most preferred embodiment, the aperture cannot be seen during normal use of the housing. For externally mounted pods the fact that a would-be burglar cannot see the external aperture and in particular cannot see into the structure to which the housing is attached may further reduce the risk of burglary.

Ideally the underfloor aperture is from 5 cm to 50 cm in diameter, more preferably from 10 cm to 35 cm in diameter and most preferably from 18 cm to 32 cm in diameter. The external aperture may be elongate in shape. A preferred external aperture size for a cat is 18 cm by 32 cm. For a dog the preferred aperture size is 20 cm by 36 cm.

Ideally the connecting aperture is also in the size range given above in relation to the external aperture, although the connecting aperture may be any desired size. Most preferably the connecting aperture is 17 cm by 22 cm.

The connecting aperture may comprise an adaptor tube for connecting the pod to a structure surface. For example, the adaptor tube may provide a passageway through a wall of the structure.

The adaptor tube may be extendible to allow the housing to adapt to different structures. For example the tube may be telescopic.

A set of adaptor tubes may be provided to fit different structure and/or animal sizes.

The housing may be suspendable from a surface of a structure, for example by means of bolts and/or screws. Additionally or alternatively the housing may comprise one or more ground engagable support struts or legs.

The pod may be free-standing. In one embodiment the pod comprises an internal ‘kennel’ which can be positioned in a room for use by an animal.

The housing may be attachable to the exterior or interior surface of a structure such that the underside of the housing is positioned over an external or internal surface via which the animal gains access into and out of the structure and to and from the external/internal environment. The distance between the underside of the housing and the external/internal surface is preferably no more than the shoulder height of the animal. For example, the underside may be from 5 cm to 30 cm above ground level or other external/internal surface. More preferably the underside may be from 10 cm to 25 cm above ground level or other surface, more preferably from 12 cm to 23 cm above ground level or other surface, and in a most preferred embodiment the underside of the housing is from 16.5 cm to 21 cm above ground level or other surface.

When the housing is intended for use by a cat the underside may be about 17.5 cm above ground level or other surface. When the housing is intended for use by a dog the underside may be about 30 cm above ground level or other external surface.

The housing may include a generally L-shape base member comprising the floor and a back or side wall.

The base may comprise a structure-adjoining wall section in which a connecting aperture is located, and an underside wall section extending outwardly from the structure-adjoining wall section and comprising at least part of the external aperture. The underside wall section preferably extends outwardly from the structure-adjoining wall section at an angle of about 90 degrees.

The housing may be constructed in one piece. Alternatively the housing may be formed from a number of members.

The housing may comprise a roof or outer shell.

The roof may be formed from one or more roof panels. Each of the panels may be formed from the same or different material.

The roof may comprise or include one or more removable segments. Removal of the segment/s may allow access to the interior of the housing.

At least part of the roof may be movable away from the floor. The at least part of the roof may be movable by means of a pressurised strut.

The roof may be at least partly or continuously curved.

The roof may be attached directly to the floor. Alternatively the housing may comprise a side wall which connects to roof and a floor.

The roof may be substantially dome shaped and sized to fit the floor to provide the housing. In a preferred embodiment the housing is substantially quarter-sphere shaped. The housing may be generally in the form of an ellipsoidal segment. For example the housing may be substantially quarter ovoid shape.

The roof member may be removably attachable to the floor and may be formed from one or more roof panels which may also be removably attachable to the base member and/or to one or more other roof panels.

The roof member of the housing and/or one or more roof panel(s) may be movable to provide access to the interior of the housing. The roof member and/or one or more roof panel(s) may remain in association with the housing during movement. Movement of the roof member and/or roof panel(s) may be automatically and/or manually controllable.

In a preferred embodiment the roof member or one or more roof panel(s) may be mounted on a controllable strut to allow assisted lifting. The strut may be a pressurised strut for example a hydraulic, gas-assisted, air, spring, counterweight or damper unit. In a most preferred embodiment the roof member is arranged such that when the housing is attached to a structure, the roof member is moveable upwardly away from the underside wall section and outwardly away from the structure-adjoining wall section, most preferably by means of a strut.

In a preferred embodiment the strut may be activated by compression release, for example by applying a force to a movable roof member or roof panel. To make sure the strut is not activated accidentally the housing may further comprise a locking mechanism. Because the roof member is under pressure from the strut even when closed any tendency for wind vibration against the base member or the structure is reduced.

Incorporating such an opening device into an animal housing may reduce the need to bend down to open it therefore making it easier to open and clean whilst also reducing the risk of loss or damage to the section which is movable.

The pod may further comprise an animal litter tray or compartment. The animal litter compartment may be removable for ease of cleaning.

The pod may further comprise a food tray compartment. The food compartment may be removable.

In a preferred embodiment the housing comprises an internal animal walkthrough or walkway area in addition to one or more compartments, such than in use of the housing an animal can move around in the housing. For example, if the pod is externally-mounted on a wall then a walkthough area would allow an animal to move from the structure through a connecting aperture into the walkthrough area inside the housing and then out through an external aperture without having to step into the compartment's. If the animal desires to use the litter compartment access to it may be gained from inside the housing. This feature is much improved over conventional litter trays where the animal has to step straight into the litter.

The housing may comprise a compartment for animal litter or food having an upwardly extending perimeter lip. In this embodiment the roof area preferably further comprises a perimeter lip engaging element, which at least partially seals the perimeter of the compartment from the remainder of the interior of the housing, when the housing is closed, in other words when the roof area is attached to the base area.

Ideally the perimeter lip engaging element comprises a downwardly extending, compartment-engaging lip which is arranged to engage with the upwardly extending perimeter lip of the compartment.

This feature may be advantageous in preventing food and litter from being pushed or scraped out of the compartment by an animal during use. When the housing needs to be cleaned the roof member can be lifted using for example the mechanisms described above. Alternatively or additionally the roof may be removable. Because of the engaging element most litter and/or food will be confined to the compartment making cleaning easier.

Animal housings, in particular those incorporating litter or food, can suffer from the disadvantage that odours can linger in and around them, in some cases causing the structure in which they are located to have a bad odour. It may be desirable to ventilate the housing, in particular to make it a more pleasant environment for an animal using it. An air vent may be located in or around the roof member to allow flow of air through the housing.

In a preferred embodiment the housing may comprise a ventilating structure, the ventilating structure comprising a channel through which in use air can flow to ventilate the housing, the channel comprising at least one aperture in fluid communication with the interior of the housing and at least one aperture in fluid communication with the external environment.

Incorporating such a ventilation system into an animal housing may improve the environment inside the housing, making it more appealing and comfortable for an animal to use and also helping to prevent odours from the housing entering the structure.

The channel may be in the form of a pair of substantially parallel walls. The ventilating structure may be an integral part of the roof structure and/or may be in the form of a ventilating roof panel. The walls may be held apart by ribs located between them. Such a double wall structure may also provide additional advantages in the form of sound reduction and heat insulation. Alternatively or additionally the housing may further comprise one or more ventilating fans.

In some embodiments the walls taper towards each other as they approach a vent to speed air flow.

Alternatively or additionally the housing may comprise an air vent located in or around the roof member to allow flow of air through the housing preferably from the external aperture.

The roof member may be transparent or translucent. In a preferred embodiment a section of the roof member may be transparent or translucent. This transparent or translucent section may advantageously allow the interior of the housing to be naturally lit, and may also allow an animal using the housing to see the external environment surrounding the housing. Alternatively or additionally the housing may comprise additional lighting, for example LED lights or a luminescent panel.

The connecting aperture and/or underfloor aperture of the housing may comprise an openable member which occludes or seals the aperture(s) when not in use or which can be opened by the animal for the animal to pass through the aperture(s).

The openable member may be a hinged or pivotable flap, for example. The openable member may be located in the adaptor wall tube of the connecting aperture. Ideally the openable member associated with the external aperture is perforated.

The animal may be a dog, cat, gerbil, rabbit or other domesticated or non-domesticated animal. Preferably the animal is a cat.

One disadvantage with known flaps is that they can pose a security risk, since it has been known for people to steal items through cat and dog flaps and to use the flaps as a means to unlawfully enter a building. Cat and dog flaps can also, due to their design allow weather such as rain and draughts to enter a building.

According to a second aspect of this invention, there is provided a housing for allowing an animal access into and out of a structure, the housing being attachable to an exterior surface of the structure above ground level and comprising (a) at least one connecting aperture which, when the housing is attached to an exterior surface of the structure, links an interior of the structure to an interior of the housing and (b) at least one external aperture which, when the housing is attached to an exterior surface of the structure, is positioned at least partially on an underside of the housing and links an interior of the housing with an external environment.

The pod may therefore when in use allow an animal to move freely between the inside of the structure and the external environment.

According to a third aspect of the present invention there is provided a ventilated housing for use by an animal comprising at least one entry and/or exit aperture and a ventilating structure, the ventilating structure comprising a channel through which in use air can flow to ventilate the housing, the channel comprising at least one aperture in fluid communication with the interior of the unit and at least one aperture in fluid communication with the external environment.

Incorporating such a ventilation structure into a housing may improve the environment inside the housing, making it more appealing and comfortable for an animal to use.

Alternative features of the third aspect of the present invention are as described in relation to the first and second aspects.

Generally available animal housings comprise a housing with a door. The housing can be cleaned either through the door or by removing a lid portion of the housing to gain access to the interior. In both cases the user has to bend down to ground level to pick up or open the housing. Additionally, if the lid portion has been removed there is a risk that it could be blown away and/or broken in some way.

Therefore according to a forth aspect of the present invention there is provided an animal housing comprising a base member, a roof member, and at least one exit and/or entry aperture, wherein a section of the housing is movable by means of a opening device between a closed and an open position to provide access to the interior of the housing, wherein the section remains associated with the housing in both the open and closed positions.

Additional features of the fourth aspect of the present invention are as described in relation to the first, second and third aspects.

As stated above in relation to the other aspects of the present invention animal housings, such as those described, need to be regularly cleaned.

In animal litter trays it is a problem, particularly in relation to cats, that the litter and excrement is scraped out of the litter try by the animal.

Therefore according to a fifth aspect of the present invention there is provided an animal housing comprising a base area having a compartment for animal litter or food, the compartment having an upwardly extending perimeter lip, and a roof area which is removably attachable to the base area, the roof area comprising a perimeter lip engaging element, which at least partially isolates the compartment from the interior of the housing, when the housing is closed, in other words when the roof area is attached to the base area.

Additional features of the fifth aspect of the invention are described in relation to the first, second, third and fourth aspects of the present invention.

According to a sixth aspect of the present invention there is provided an external animal toilet pod comprising a housing which includes an aperture for allowing an animal access into and out of its interior, a floor, and a toileting facility positioned on the floor.

The pod may be attachable to an external surface of a structure.

The aperture for allowing access into and out of the interior of the housing may be at least partly formed in the floor of the pod. Alternatively, for example, side access may be provided with no part of the aperture being in the floor.

The toileting facility may be a litter tray or the like.

There may be provided means for detecting if the toileting facility has been used so that this could be communicated to a pet owner so that the facility can be cleaned.

Alternative features of the sixth aspect are as described in relation to the other aspects.

According to a seventh aspect of the present invention there is provided an external animal toilet pod comprising a housing which is attachable to an exterior surface of a structure above ground level and comprising: (a) at least one connecting aperture which, when the housing is attached to an exterior surface of the structure, links an interior of the structure to an interior of the housing; (b) at least one external aperture which links an interior of the housing with an external environment; and (c) a toileting facility in the interior of the housing.

Alternative features of the seventh aspect are as described in relation to the other aspects.

In a similar fashion to the seventh aspect, an eighth aspect of the present invention provides an internal animal toilet pod which is attachable to an interior surface of a structure and allows the animal to access an external environment.

Other features of the present invention will become apparent from the following examples. Generally speaking the invention extends to any novel one, or any novel combination, of the features disclosed in this specification (including any accompanying claims and drawings). Moreover unless stated otherwise, any features disclosed herein may be replaced by an alternative feature serving the same or a similar purpose.

In order that the invention may be more fully understood, a preferred embodiment of a housing, in accordance therewith, will now be described by way of example only and with reference to the accompanying illustrative drawings of which:

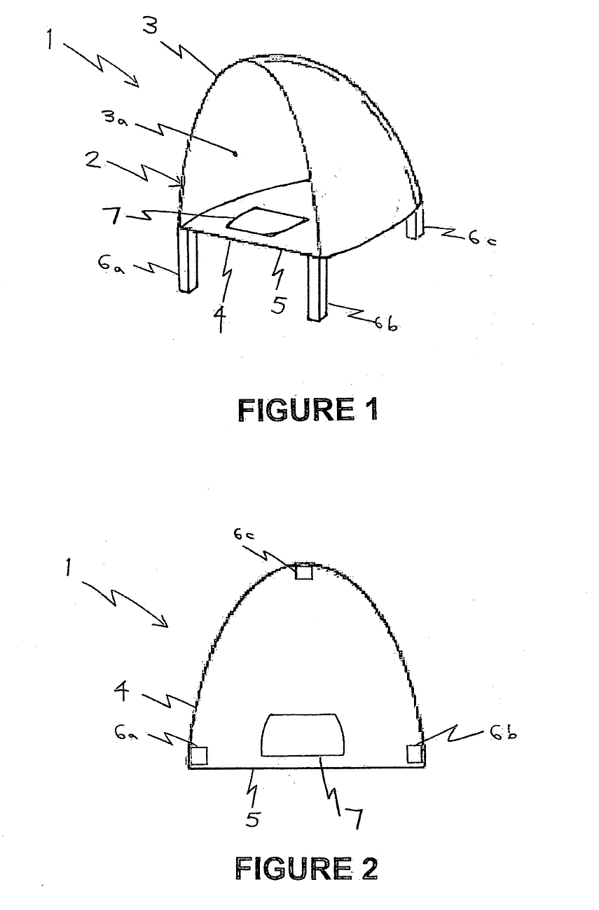

FIG. 1 is a front perspective view of an animal accommodation pod formed according to an embodiment of the present invention;

FIG. 2 is an underside view of the pod of FIG. 1;

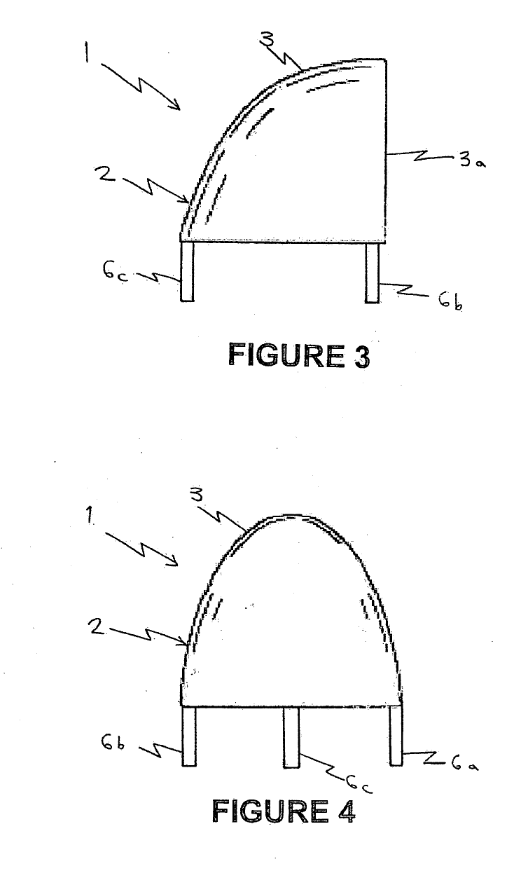

FIG. 3 is a side elevation of the pod of FIG. 1;

FIG. 4 is a rear elevation of the pod of FIG. 1;

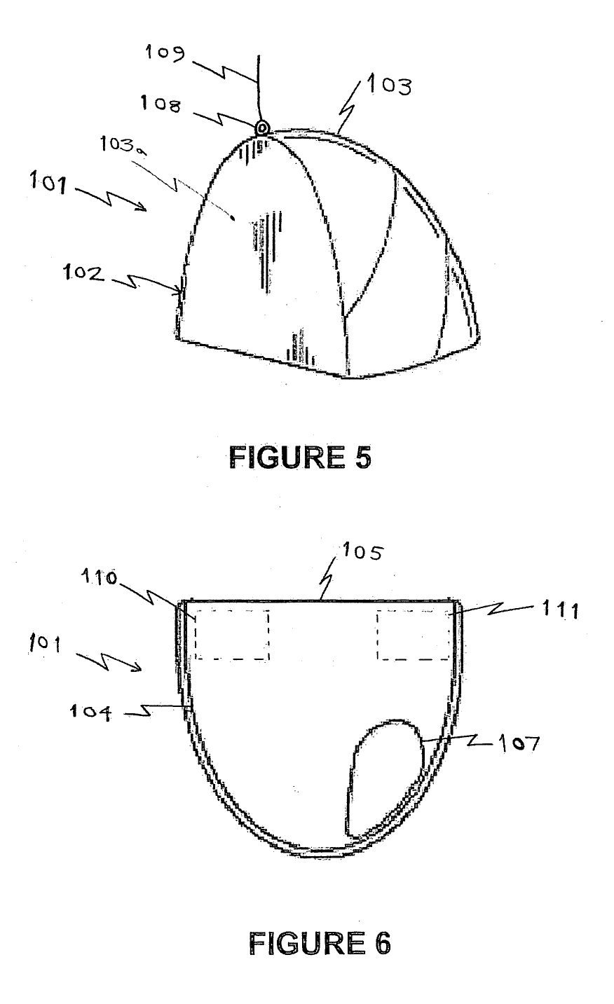

FIG. 5 is a front perspective view of a pod formed according to an alternative embodiment;

FIG. 6 is an underside view of the pod of FIG. 5;

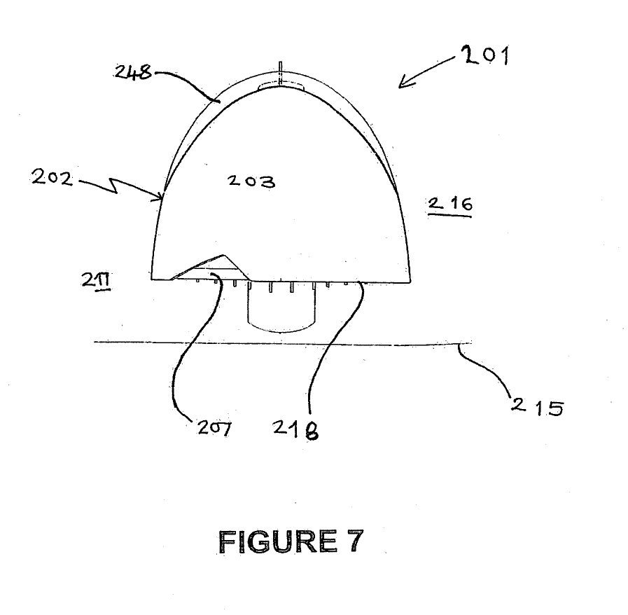

FIG. 7 shows a rear view of a pod formed according to an alternative embodiment attached to an exterior surface of a structure;

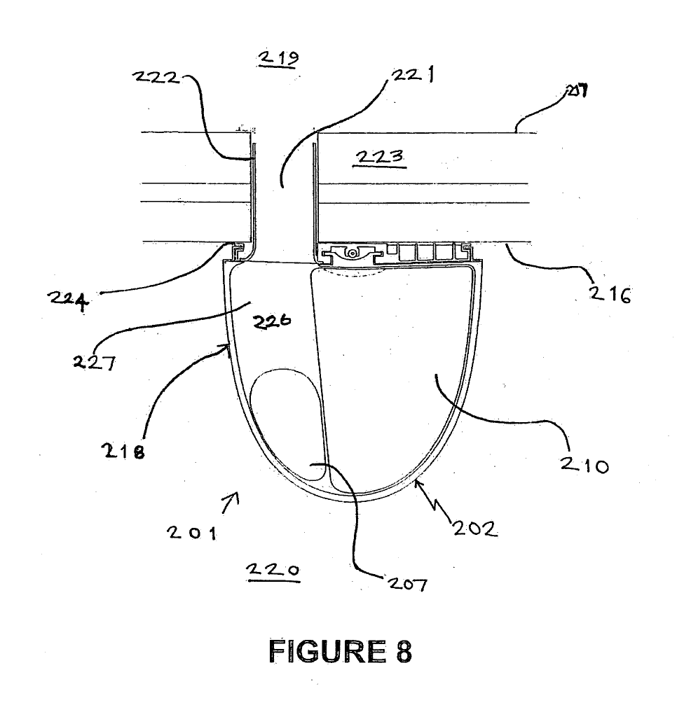

FIG. 8 shows a plan view section of the pod of FIG. 7;

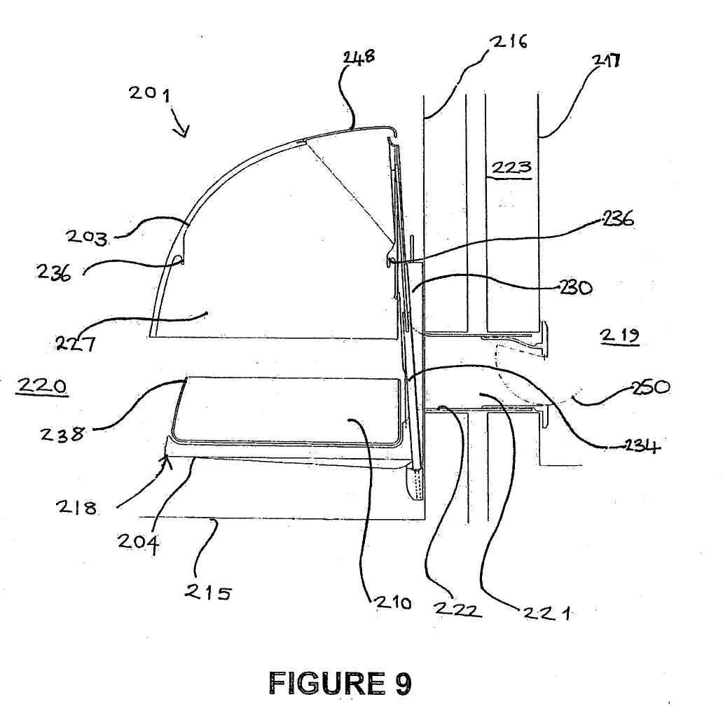

FIG. 9 shows a side view section through the pod of FIG. 7 in its open configuration;

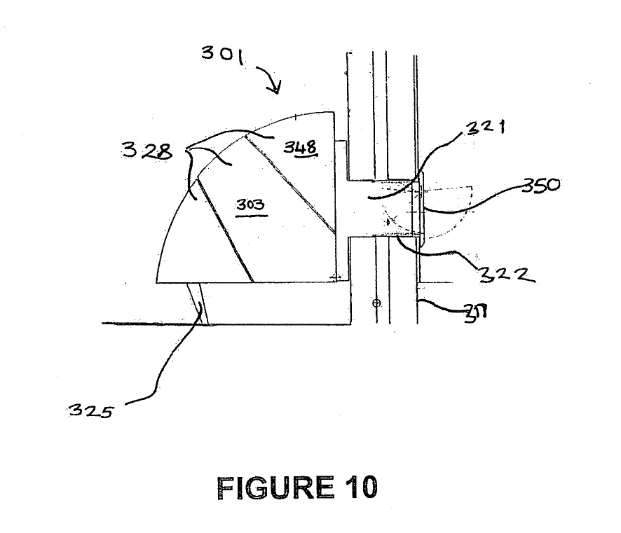

FIG. 10 shows a side view of a pod formed according to an alternative embodiment attached to an interior surface of a structure;

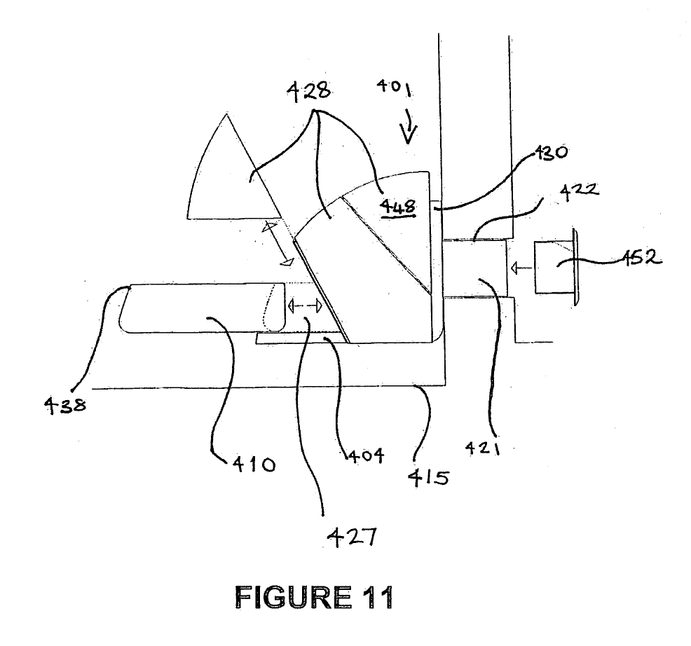

FIG. 11 shows an exploded side view of a pod formed according to an alternative embodiment attached to an exterior of a structure;

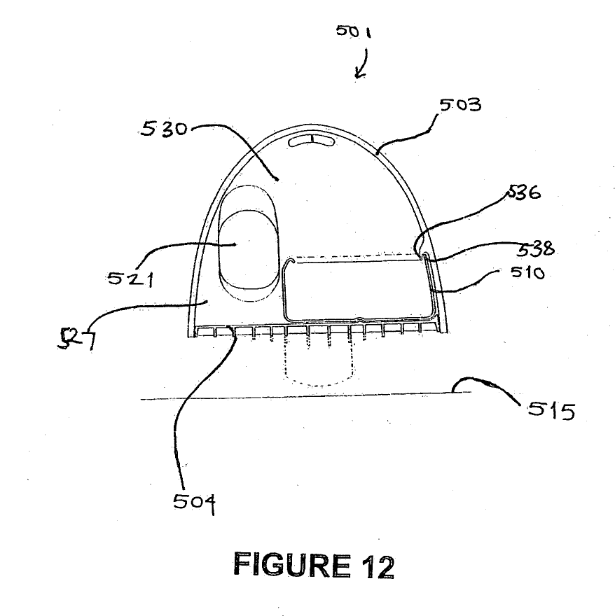

FIG. 12 shows a front view section through a pod formed according to an alternative embodiment;

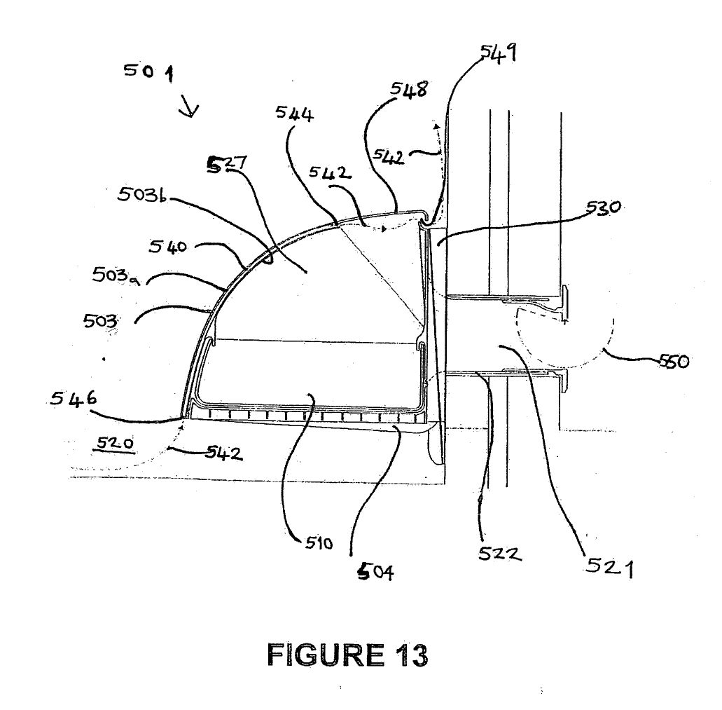

FIG. 13 shows a side view section through a pod formed according to an alternative embodiment;

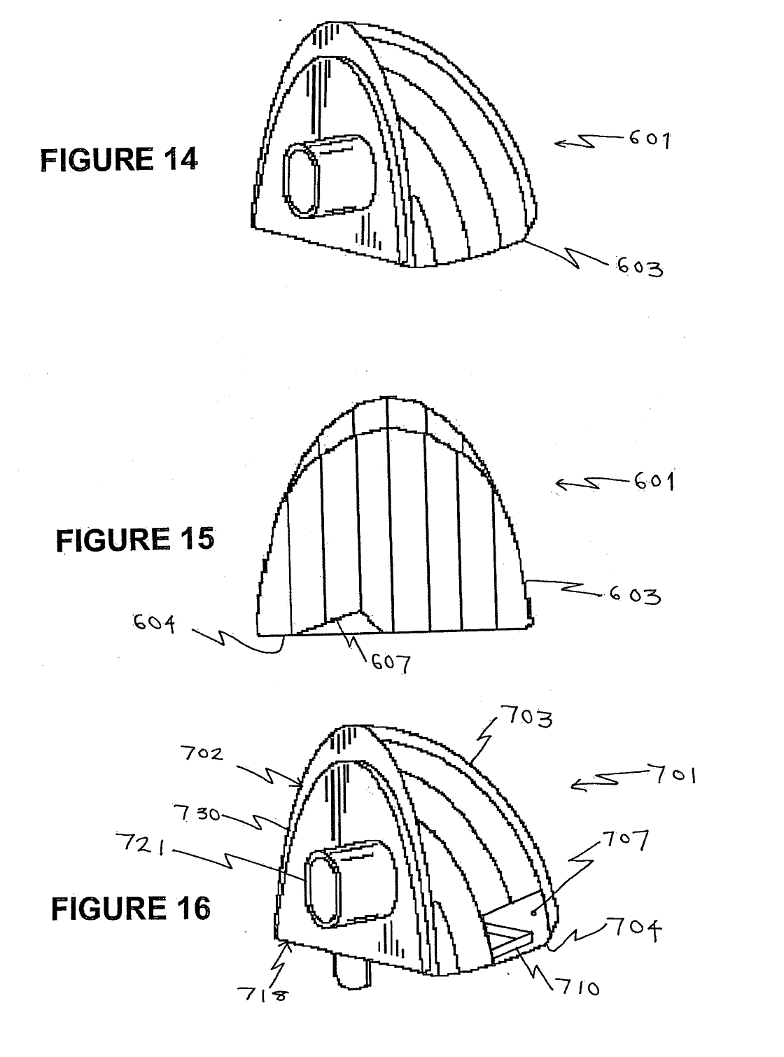

FIG. 14 is a front perspective view of a pod formed according to a further embodiment;

FIG. 15 is a rear elevation of the pod of FIG. 14;

FIG. 16 is a perspective view of an external animal toilet pod formed according to an alternative aspect;

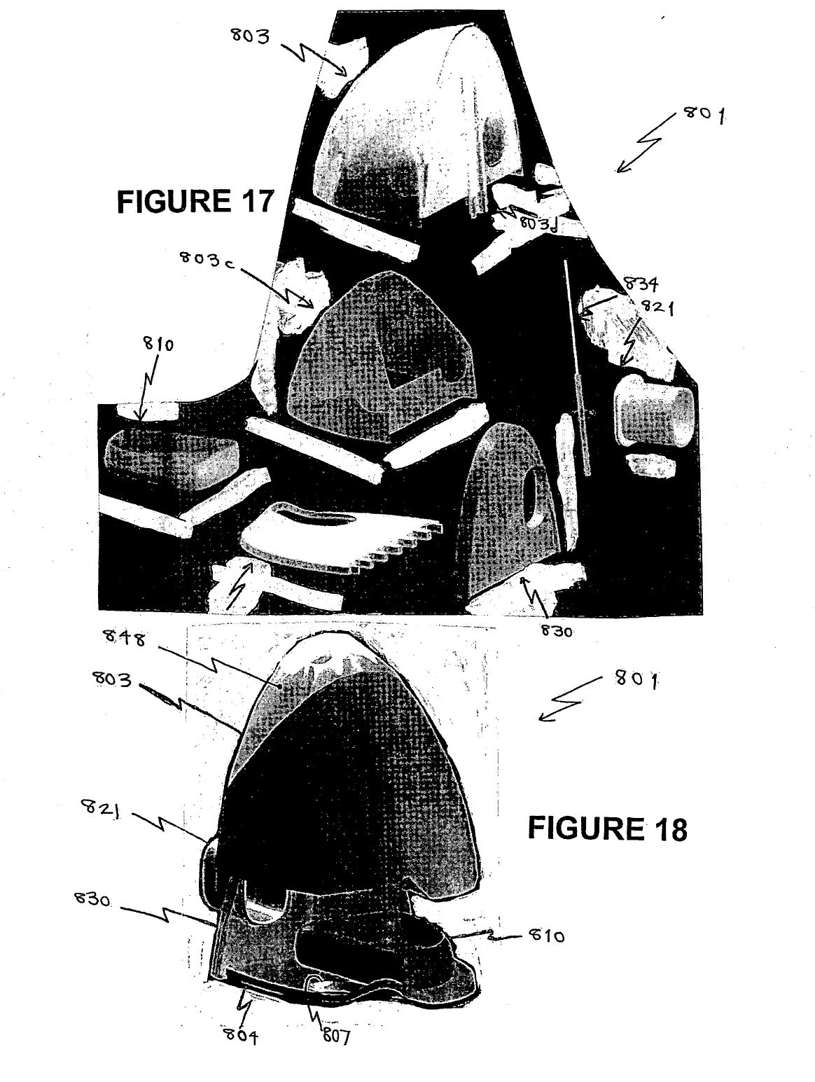

FIG. 17 is an exploded view illustrating the components of a pod formed according to an alternative embodiment of the first aspect;

FIG. 18 is a rear perspective view of the pod of FIG. 17 shown assembled and in an open position;

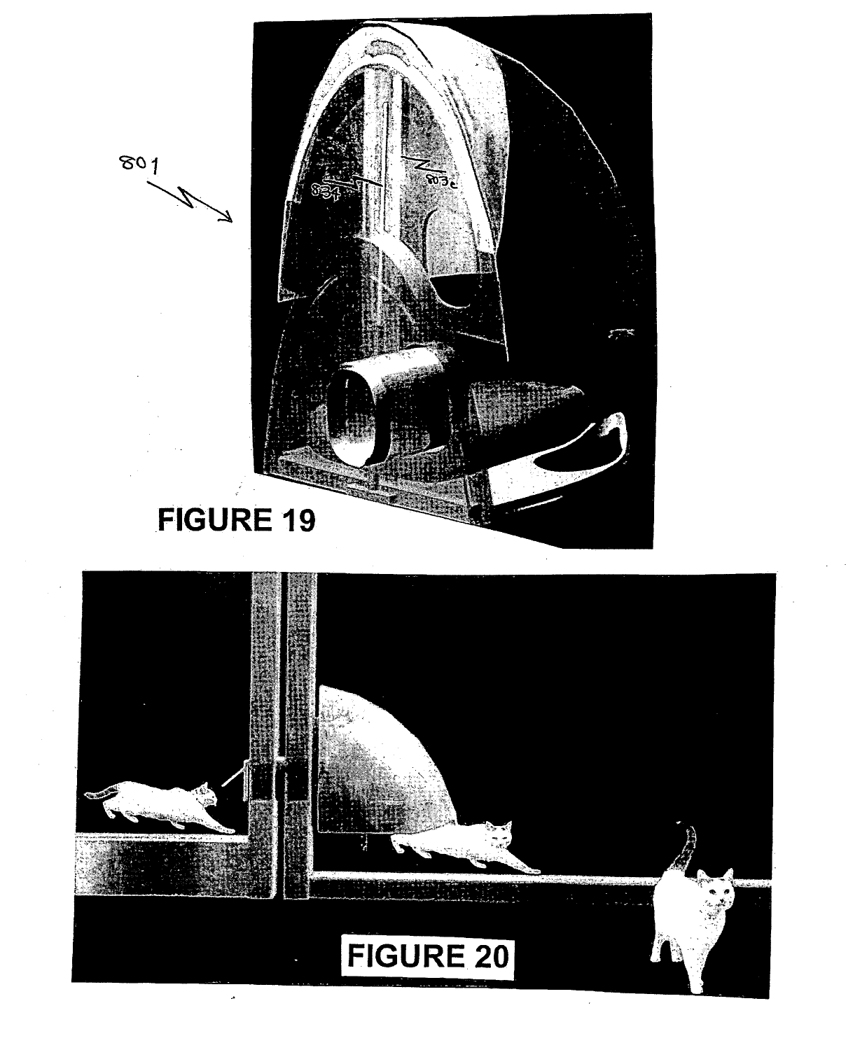

FIG. 19 is a front perspective view of the pod of FIG. 18;

FIG. 20 is a side view of a structure having the pod shown in FIGS. 17 to 20 mounted on its exterior;

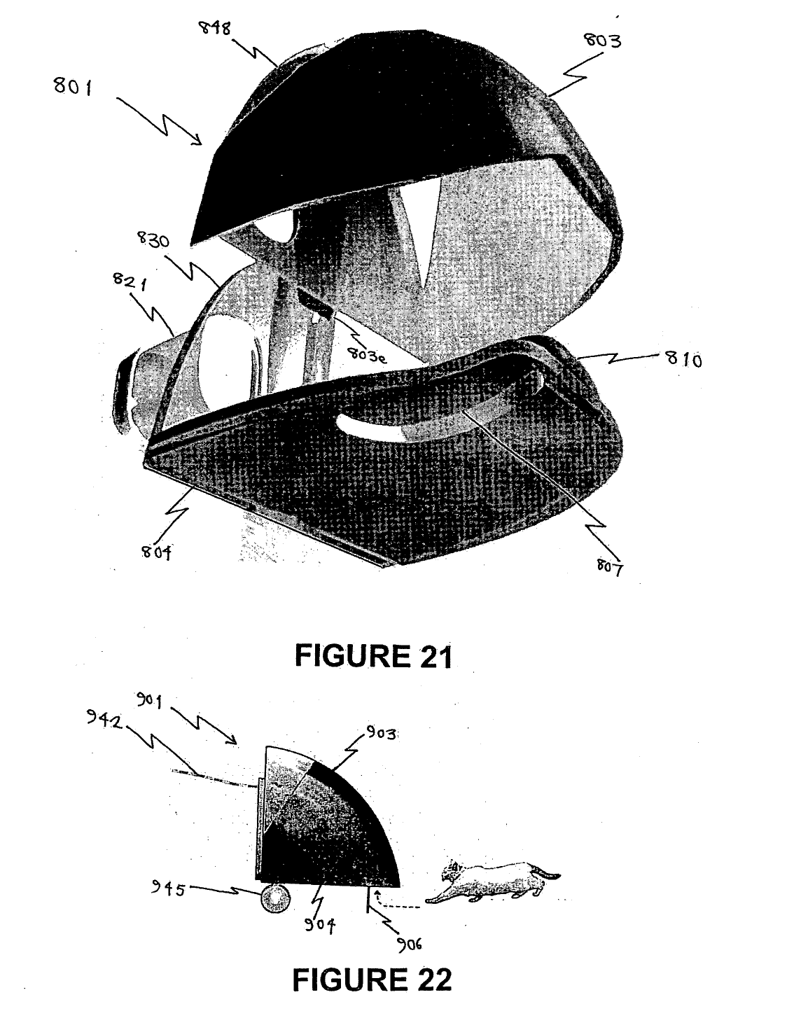

FIG. 21 is an underside perspective view of the pod of FIG. 19; and

FIG. 22 is a side view of an internal cat pod formed according to an alternative embodiment.

All figures are schematic.

Referring first to FIGS. 1 to 4 there is shown an animal accommodation pod generally indicated 1. The pod 1 comprises a housing 2 which is generally quarter ovoid in shape. The housing 2 comprises a hood-like roof 3 and a floor 4.

The floor 4 is generally arch-shape and comprises a straight front edge 5 and a generally U-shape body extending therefrom.

The housing 2 is supported on three legs 6a-6c which depend from the floor 4. The legs 6a-6c are arranged in a triangular configuration with the legs 6a and 6b being positioned at either side of the front edge 5 and the leg 6c being positioned at the bight of the U-shape floor.

The floor 4 includes an aperture 7 positioned centrally in the front edge 5.

The roof 3 comprises generally quarter-ovoid, semi-transparent curved panel which extends all the way to the floor 4, where it joins the periphery of the floor. The roof 3 also includes a transparent front panel 3a which extends to the front edge 5 of the floor so that the housing 2 forms an enclosure.

Because the roof 3 forms an enclosure, the only access to the interior of the pod 1 is via the aperture 7 in the floor 4. The aperture 7 constitutes and underfloor entrance/exit to the interior of the housing 2.

Referring now to FIGS. 5 and 6 there is shown a pod 101 formed according to an alternative embodiment. The pod 101 is similar to the pod 1 shown in FIGS. 1 to 4 in that it comprises a generally quarter ovoid housing 103. In this embodiment the front panel 103a and the curved roof panel are formed from generally opaque material.

The housing 102 comprises a ring 108 from which the pod 101 can be suspended via a rope 109 or the like.

As can be seen from FIG. 6, the floor 104 of the pod 101 includes an aperture 107, which in this embodiment is positioned towards the bight of the generally U-shape floor 104. In addition, towards the front edge 105 are positioned two compartments 110, 111. The compartment 110 is a litter tray and the compartment 111 is a food tray.

Referring now to FIGS. 7, 8 and 9 there is shown a pod 201 formed according to an alternative embodiment.

From FIGS. 7, 8 and 9 it can be seen that during use the pod 201 is attached above ground level 215 to an external surface 216 of a structure 217. The housing 202 is roughly quarter-ovoid in shape and comprises a base member 218 a roof member 203 and an animal litter tray 210.

The housing 202 in use connects the interior 219 of the structure 217 with the external environment 220 via a connecting aperture 221, and an external aperture 207 which is positioned largely on the underside of the floor 204 of the base member 218.

This pod 201 when in use allows an animal to move freely between the structure 217 and the external environment 220 through the connecting 221 and external 207 apertures.

The housing 202 may be constructed from any suitable plastics, metal, synthetic or natural material but is most preferably constructed from plastics. The roof structure 203 may be smooth or faceted.

Ideally the external aperture 207 is 18 cm by 32 cm and the connecting aperture 221 is 17 cm by 22 cm.

The connecting aperture 221 comprises an adaptor wall tube 222, which is most preferably telescopic and provides a passageway through a wall 223 of the structure 217. Ideally the adaptor wall tube 222 is adjustable to accommodate a variety of wall and/or door types. Ideally the adaptor wall tube 222 will be sized to fit a number of different currently available animal flaps.

The pod 202 is preferably suspendable from the outside surface 216 of the structure 217, by means of bolts and/or screws 224, but may additionally or alternatively be supported by a support strut 325 (as shown in FIG. 10).

The housing 202 also has a dedicated walkthrough area 226 along which an animal can walk without having to step into the litter and/or food tray 210. This feature can be seen best in FIG. 8.

The roof 203 may be constructed in one piece as shown in FIG. 7 or it may instead be formed from a number of roof panels 328 as shown in FIG. 10.

FIG. 9 shows an embodiment where the base member 218 comprises a structure-adjoining wall section 230 in which the connecting aperture 221 is located, and an underside floor section 204, located at substantially right angles to the structure-adjoining wall section 230, and in which at least part of the external aperture 207 is located (in FIG. 9 the external aperture is hidden by the litter tray 210). The roof member is substantially dome shaped and is sized to fit the base member to provide the housing.

Ideally the roof member 203 of the housing 202 and/or one or more roof panel(s) is movable to provide access to the interior 227 of the housing.

In a preferred embodiment the roof member 203 lifts upwardly and outwardly away from the base section 218 from a closed position as shown in FIG. 7 into an open position as shown in FIG. 9. Ideally this movement is controlled by a pressurised strut for example a hydraulic or gas assisted strut 234.

In the open position, a user can gain access to the litter tray 210, for example for cleaning purposes. The strut 234 is preferably activated by compression release, for example by applying a form to the roof member 203. To make sure the strut 234 is not activated accidentally the housing 202 may further comprise a locking mechanism (now shown).

In an alternative embodiment shown in FIG. 11, one or more roof panels 428 may be movable to provide access to the interior 427 of the housing 402. Again this movement is ideally controlled by a hydraulic or gas assisted strut, but may alternatively be manually movable. Movement of a roof panel 428 can be seen in FIG. 11 where a roof panel 428 is shown in its open position, so that a user can gain access to the litter tray 410, for example for cleaning purposes.

The roof member 203 preferably also comprises an internal perimeter lip-engaging element 236 which can be seen in FIG. 9. When the housing 202 is closed, in other words when the roof member 203 is attached to the base area 218, the lip engaging element 236 partially seals the perimeter 238 of the litter tray 210 from the remainder of the interior 227 of the housing 202. FIGS. 12 and 13 shows sections through a closed housing 502, showing the roof member 503 attached to the base area 518. The internal perimeter lip engaging element 536, can be seen to be at least partially sealing the perimeter 538 of the litter tray 510 from the remainder of the interior 527 of the housing 501.

When the housing 202 needs to be cleaned the roof member 203 can be lifted into the position as shown in FIG. 9. The roof member 203 may be completely removable to assist in cleaning.

Because of the engaging element 236 most litter will be confined to the litter tray 210 making cleaning easier.

The roof member 203 may also comprise a transparent or translucent section 248.

Referring now to FIG. 13, a pod 501 may comprise a ventilation structure firstly to insulate and cool the roof member 503. The ventilation structure may comprise a ventilated twin wall cover 503a and 503b with air passage between the inner 503a and outer 503b walls. The ventilating structure may comprise a channel 540 through which in use air can flow to ventilate and cool the roof member 503 of the housing 502, together with assisting the ventilation of the housing interior 527. The airflow is demonstrated by arrow 542. The channel 540 has one aperture 544 in fluid communication with the interior 527 of the housing 502 and one aperture 546 in fluid communication with the external environment 520. The airflow leaves the housing 502 through an adjustable vent 549 in the top of a housing translucent section 548.

The housing 502 also comprises further ventilation to remove odours and cool the inside of the housing 502 by airflow through the external aperture 507 and exiting through the adjustable vent 549 in the top of a housing translucent section 548.

The connecting aperture 521 preferably has an openable member, for example a flap 550 which may be lockable to prevent use of the connecting aperture 521 by an animal. The flap 550 may be located in the adaptor wall tube 522 of the connecting aperture 521. Alternatively the connecting aperture 421 may have a removable stopper 452 as shown in FIG. 11.

In some embodiments the external aperture 207 has a hinged, swivelable or pivotable flap or a removable stopper, for preventing use of the external aperture 207 by an animal. The flap or stopper may be perforated to allow through ventilation.

Referring now to FIGS. 14 and 15 there is shown a pod 601 formed according to an alternative embodiment. The pod 601 is very similar to the pod shown in FIG. 7 except that the roof 603 comprises a single ribbed panel. It will be noted that the aperture 607 extends partly into the roof 603 from the floor 604.

Referring now to FIG. 16 there is shown an external animal toilet pod 701 formed according to the sixth aspect of the present invention. The pod 701 comprises a housing 702 which includes a roof 703 and a base member 718 including floor 704 and a wall section 730. The wall section 730 includes a connecting aperture 721 for providing access from the interior of the housing 702 into a structure to which the pod 701 can be mounted. The roof 703 includes a lateral aperture 707 by which entry into and exit from the interior 712 of the housing can be achieved. The interior 712 of the housing includes a removable litter tray 710.

Referring now to FIGS. 17 to 20 there is shown an exploded view of an external cat toilet pod 801 formed according to an alternative embodiment of the first aspect of the present invention.

The pod 801 comprises a housing which includes: a twin shell roof 803 formed from an opaque inner 803c and a transparent outer shell 803d; a base member 818 formed from a floor 804 and an end wall 830; a cat litter tray 810; and a gas sprung strut 834. The outer shell 803d includes a connecting arm 803e which is slidably received in a corresponding slot (not shown) in the internal face of the wall 830.

The outer shell 803d also includes an orifice for receiving the connecting tube 821. The inner shell 803c fits within the outer shell 803d.

The floor 804 includes an aperture 807 and a plurality of teeth 840 which engage in corresponding recesses (not shown) in the internal face of the wall 830 to connect them together. The inner shell 803c does not completely fill the outer shell 803d, which creates a transparent section 848 in the roof.

Referring now to FIG. 22 there is shown an internal cat toilet pod 901 formed according to an alternative embodiment.

The pod 901 is similar to the pod 1 shown in FIG. 1. In this embodiment the floor 904 is supported above the ground by a leg 906 and a pair of wheels 945, castors or the like. This allows the pod to be moved easily.

The pod 901 further comprises a fan 941 (not shown) linked to an external vent tube 942 which can be placed in an open window or other external vent. The fan creates a negative pressure which ensures that smells from the interior of the pod 901 are vented to the exterior of a structure.

1. An animal accommodation pod comprising a housing including a floor which is raised, in use, above a surface, in which the floor includes one or more apertures for providing underfloor entry into and exit from the interior of the pod.

2. A pod as claimed in claim 1, in which the pod is attachable to an interior or exterior surface of a structure.

3. A pod as claimed in claim 2, in which the pod comprises a connecting aperture which, when the pod is attached to a structure surface, links the interior of the pod to the exterior or interior of a structure.

4. A pod as claimed in claim 3, in which the connecting aperture comprises an adaptor tube for connecting the pod to a structure surface.

5. A pod as claimed in claim 4, in which the adaptor tube provides a passageway through a wall of the structure.

6. A pod according to claim 4, in which the adaptor tube is telescopic.

7. A pod according to claim 2, in which the housing is suspendable from a surface of the structure.

8. A pod as claimed in claim 1, in which the housing is free-standing.

9. A pod according to claim 1, further comprising one or more ground-engagable support legs.

10. A pod according to claim 1, in which, in use, the floor is from 5 cm to 30 cm above a surface.

11. A pod according to claim 1, in which 100% of the underfloor aperture is positioned within the floor area.

12. A pod as claimed in claim 1 in which the housing comprises a roof.

13. A pod according to claim 12, wherein the roof is formed from one or more roof panels.

14. A pod as claimed in claim 12, in which the roof comprises or includes one or more removable segments.

15. A pod as claimed in claim 12 in which at least part of the roof is movable away from the floor.

16. A pod according to claim 15, wherein the at least part of the roof is movable by means of a pressurised strut.

17. A pod as claimed in claim 12 in which the roof is at least partly curved.

18. A pod as claimed in claim 12, in which the roof is continuously curved.

19. A pod as claimed in claim 12, in which the roof is attached directly to the floor.

20. A pod as claimed in claim 1, in which the housing includes a generally L-shape base member comprising the floor and a side wall.

21. A pod as claimed in claim 1, in which the housing is generally in the form of an ellipsoidal segment.

22. A pod according to claim 1, further comprising an animal litter compartment.

23. A pod according to claim 1, further comprising a food compartment.

24. A pod according to claim 12, in which the floor member comprises a compartment for animal litter or food having an upwardly extending perimeter lip and the roof member comprises a perimeter lip engaging element, which at least partially seals the perimeter of the compartment, when the housing is closed.

25. A pod according to claim 24, further comprising an internal animal walkway area, such that in use an animal can move inside the housing without having to step into the compartment.

26. A pod according to claim 1, further comprising a ventilating structure, the ventilating structure comprising a channel through which in use air can flow to ventilate the housing, the channel comprising at least one aperture in fluid communication with the interior of the housing and at least one aperture in fluid communication with the external environment.

27. A pod according to claim 1, further comprising a transparent or translucent section.

28. An animal accommodation pod for allowing an animal access into and out of a structure, the housing being attachable to an exterior surface of the structure above ground level and comprising (a) at least one connecting aperture which, when the housing is attached to an exterior surface of the structure, links an interior of the structure to an interior of the housing and (b) at least one external aperture which, when the housing is attached to an exterior surface of the structure, is positioned at least partially on an underside of the housing and links an interior of the housing with an external environment

29. An external animal toilet pod comprising a housing which is attachable to an exterior surface of a structure above ground level and comprising: (a) at least one connecting aperture which, when the housing is attached to an exterior surface of the structure, links an interior of the structure to an interior of the housing; (b) at least one external aperture which links an interior of the housing with an external environment; and (c) a toileting facility in the interior of the housing.

30. (canceled)
